(19) United States
(12) Patent Application Publication
(10) Pub. No.: US 2024/0117582 A1
(43) Pub. Date: Apr. 11, 2024

(54) RECOVERY DEVICES FOR OIL SPILLING ON WATER, CONTROL METHODS THEREOF, AND RECOVERY VESSELS

(71) Applicant: CHANGZHOU UNIVERSITY, Changzhou (CN)

(72) Inventors: Hong JI, Changzhou (CN); Jie GUO, Changzhou (CN); Ke YANG, Changzhou (CN); Juncheng JIANG, Changzhou (CN); Zhixiang XING, Changzhou (CN); Ting WANG, Changzhou (CN)

(73) Assignee: CHANGZHOU UNIVERSITY, Changzhou (CN)

(21) Appl. No.: 18/332,673

(22) Filed: Jun. 9, 2023

Related U.S. Application Data
(63) Continuation-in-part of application No. PCT/CN2023/081244, filed on Mar. 14, 2023.

(30) Foreign Application Priority Data
Oct. 11, 2022 (CN) 202211240097.4

(51) Int. Cl. E02B 15/04; B01D 17/04; B01D 17/12; B63B 39/02; B63B 79/10; C02F 1/00; C02F 1/44; E02B 15/10

(52) U.S. Cl. CPC E02B 15/048; B01D 17/045; B01D 17/12; B63B 39/02; B63B 79/10; C02F 1/001; C02F 1/008; C02F 1/44; E02B 15/10; C02F 2101/32

(57) ABSTRACT

The embodiment of the present disclosure provides a recovery device for oil spilling on water, a control method thereof, and a recovery vessel. The recovery device includes a casing, a control center, a variable pressure airbag, an oil detector, an isolation layer, a water suction pump, and a drain pipe. The casing is of a hollow structure, the hollow structure is used to accommodate an oil-water mixture and used as a temporary oil collection tank, the upper part of the casing is provided with an oil-water mixture inlet, the bottom of the casing is provided with a drain port, and the side wall of the casting is provided with an oil suction port. The variable pressure airbag is arranged outside the casing, and the variable pressure airbag is configured to adjust buoyancy of the recovery device. The water suction pump is configured to pump out water in the casing and discharge water to a water environment outside the casing through the drain pipe. The control center is arranged on the casing for controlling the volume of the variable pressure airbag and the startup and shutdown of the water suction pump.

### CROSS-REFERENCE TO RELATED APPLICATIONS

The application is a continuation-in-part application of International Application No. PCT/CN2023/081244, filed on Mar. 14, 2023, which claims priority of Chinese Patent Application No. 202211240097.4, filed on Oct. 11, 2022, the entire content of which is incorporated herein by reference.

### TECHNICAL FIELD

The present disclosure relates to the field of environmental protection technology for oil spilling on the water surface, and in particular, to a recovery device for oil spilling on water, a control method thereof, and a recovery vessel.

### BACKGROUND

An oil-spilling refers to the leakage of crude oil during transportation or operation in a process of oil exploration, oil production, storage, and transportation in seas due to various reasons, causing various risks to different waters. With the utilization and development of different waters by humans, the risk of water-surface oil-spilling as well as the threat to the ecological environment is increasing.

At present, solutions for recovering spilled oil on the sea mainly include: a physical method, a chemical method, and a biological method. The most ideal method is the physical method, which can separate oil from water without changing the chemical properties of crude oil, including mechanical device recovery or adsorption material recovery of oil-spilling, but is mainly affected by factors such as wind waves, viscosity, etc.

The existing physical method for recovering spilled oil on water mainly uses an overwater recovery device to recover the spilled oil, such as using an overwater boom to control the spilled oil and then using various methods to recover the spilled oil on water. However, the existing oil skimmer needs manual direct participation in the operation, especially for some operation areas where it is inconvenient for operators to approach, the labor intensity of the operators is high and the operating efficiency is low.

Therefore, it is desirable to provide a recovery device for oil spilling on water, a control method thereof, and a recovery vessel to make oil recovery operations more efficient and stable, so as to realize sustainable oil recovery operations.

### SUMMARY

According to one or more embodiments of the present disclosure, a recovery device for oil spilling on water is provided, the recovery device includes a casing, a control center, a variable pressure airbag, an oil detector, an isolation layer, a water suction pump, and a drain pipe. The casing is of a hollow structure, the hollow structure is used to accommodate an oil-water mixture and used as a temporary oil collection tank, the upper part of the casing is provided with an oil-water mixture inlet, the bottom of the casing is provided with a drain port, and the side wall is provided with an oil suction port. The variable pressure airbag is arranged outside the casing, which is configured to adjust buoyancy of the recovery device. One end of the water suction pump is connected to the drain port, the other end of the water suction pump is connected to the drain pipe, and the water suction pump is configured to pump out water in the casing and discharge the water to a water environment outside the casing through the drain pipe. The control center is arranged on the casing, and the control center is communicatively connected with the variable pressure airbag and the water suction pump respectively for controlling volume of the variable pressure airbag and startup and shutdown of the water suction pump.

In some embodiments, the recovery device further includes an oil detector and an isolation layer, and the isolation layer is arranged inside the casing for water penetration and oil separation. The oil detector is arranged on the inner wall of the casing to detect a position of an oil level, and when the oil level touches the oil detector, the oil detector sends a detection result to the control center. The control center is communicatively connected with the oil detector for controlling the volume of the variable pressure airbag and the startup and shutdown of the water suction pump according to the detection result of the oil detector.

In some embodiments, the recovery device further includes an oil discharge pump and an oil suction pipeline. The oil discharge pump is arranged on the isolation layer, one end of the oil suction pipeline is connected to the oil discharge pump, and the other end is connected to a recovery vessel recovering spilled oil. The oil discharge pump is configured to discharge oil collected in the casing to the recovery vessel through the oil suction pipeline. The control center is also communicatively connected with the oil discharge pump, and the control center is configured to control the startup and shutdown of the oil discharge pump.

In some embodiments, the oil-water mixture inlet is provided with a filter.

In some embodiments, the isolation layer includes a hydrophilic-oleophobic membrane and rigid filters disposed on the upper portion and lower portion of the hydrophilic-oleophobic membrane.

In some embodiments, the oil detector includes a first oil detector and a second oil detector, and a height of the first oil detector on the inner wall of the casing is higher than that of the second oil detector. The second oil detector is arranged at a connection between the isolation layer and the inner wall of the casing.

In some embodiments, the recovery device further includes an airbag support frame, the airbag support frame is arranged outside the casing, and the airbag support frame is configured to support the variable pressure airbag and fix the variable pressure airbag outside the casing.

In some embodiments, the recovery device includes a driving component for controlling movement of the recovery device. The driving component is composed of a water suction pipe, a water outlet pipe, a backup water outlet pipe, a water pump, and a connecting shaft. Electric control valves are arranged in the water outlet pipe and the backup water outlet pipe. One end of the water suction pipe is connected to the water pump, the other end of the water suction pipe is connected to the water outlet pipe and the backup water outlet pipe, and the other end of the water suction pipe is connected to the bottom of the casing through the connecting shaft. The water pump is configured to suck water in a water environment outside the casing into the water suction pipe, and discharge the water through the water outlet pipe and/or the backup water outlet pipe. The control center is communicatively connected with the electric control valves for controlling the startup and shutdown of the water outlet pipe and the backup water outlet pipe.

One of the embodiments of the present disclosure provides a recovery vessel for oil spilling on water. The recovery vessel includes a recovery vessel body and the recovery device, and the recovery vessel body includes an oil storage tank and an oil boom; the oil storage tank is configured to store spilled oil recovered by the recovery device, and the oil boom is configured to enclose an oil-spilling water area.

In some embodiments, the recovery vessel further includes a telescopic tractor, which is arranged on the recovery vessel body, its free end is connected to the recovery device, and the telescopic tractor is configured to adjust a position of the recovery device.

In some embodiments, the recovery vessel further includes a control system for controlling the telescopic tractor to adjust the position of at least one recovery device.

One of the embodiments of the present disclosure provides a control method for a recovery device for oil spilling on water. The method is executed by a control system of the recovery vessel, including: obtaining an oil distribution map of the oil-spilling water area in the oil boom; determining whether the at least one recovery device meets a preset movement condition based on the oil distribution map and an oil collection situation of the at least one recovery device; in response to a determination that the at least one recovery device meets the preset movement condition, determining a target distribution scheme and a target movement scheme based on the oil distribution map; and adjusting the position of the at least one recovery device based on the target distribution scheme and the target movement scheme.

Some embodiments of the present disclosure include the following beneficial effects.
(1) The recovery device in the present disclosure is equipped with a hydrophilic-oleophobic membrane in the inner cavity of the casing, which may temporarily store all collected oil in the inner cavity of the casing as a temporary oil collection tank. This has a good and stable oil recovery effect, improves the oil collection efficiency, and can quickly and stably respond to offshore oil-spilling operations.
(2) The recovery device and the recovery vessel in the present disclosure may cooperate with the recovery vessel body to carry out continuous and uninterrupted recovery of spilled oil on the water surface in oil-spilling water until the spilled oil is cleared, which further improves the work efficiency of oil recovery and the spilled oil recovery efficiency, realizing rapid control and restoration of the ecological environment, and solving the problem that oil recovery devices equipped on most oil recovery vessels cannot continuously recover in oil-spilling waters.
(3) The recovery vessel in the present disclosure may realize intelligent recovery of oil, so it is more advantageous to reduce labor force to reduce labor intensity and improve operating efficiency;
(4) The recovery device of the present disclosure utilizes the physical properties of oil and water and adopts a mechanical recovery method, which allows the physical and chemical properties of oil not to change, has a simple design structure and convenient operation, so the efficiency of oil recovery operation can be effectively improved.
(5) During the recovery process of the spilled oil, the recovery vessel of the present disclosure cooperates with an oil boom of the oil recovery vessel to recover the spilled oil in sequence, and the spilled oil may be controlled not to disperse further outward so that the recovery efficiency of the spilled oil is improved.

### BRIEF DESCRIPTION OF THE DRAWINGS

The present disclosure is further described in terms of exemplary embodiments. These exemplary embodiments are described in detail with reference to the drawings. These embodiments are not restrictive, in which the same numbering indicates the same structure, wherein:

FIG. 1 is an exemplary schematic diagram illustrating a longitudinal sectional structure of a recovery device according to some embodiments of the present disclosure;

FIG. 2 is an exemplary schematic diagram illustrating a top-view structure of a recovery device according to some embodiments of the present disclosure;

FIG. 3 is a diagram illustrating an exemplary structure of a hydrophilic-oleophobic membrane according to some embodiments of the present disclosure;

FIG. 4 is an exemplary schematic diagram illustrating a longitudinal cross-sectional structure of a driving component according to some embodiments of the present disclosure;

FIG. 5 is an exemplary schematic diagram illustrating a top-view structure of a driving component according to some embodiments of the present disclosure;

FIG. 6 is an exemplary schematic diagram illustrating a top-view structure of a recovery vessel according to some embodiments of the present disclosure;

FIG. 7 is a flowchart illustrating an exemplary process of recovery vessel operations according to some embodiments of the present disclosure;

FIG. 8 is a flowchart illustrating an exemplary process of a control method for a recovery device according to some embodiments of the present disclosure.

Reference marks are as follows: 1 casing; 2 oil-water mixture inlet; 2.1 fixed column; 3 control center; 3.1 water suction pump control room; 3.2 airbag control room; 3.3 oil discharge control room; 4 variable pressure airbag; 5 airbag support frame; 6.1 the first oil detector; 6.2 the second oil detector; 7 isolation layer; 7.1 rigid filter; 7.2 hydrophilic-oleophobic membrane; 8 oil discharge pump; 8.1 oil suction pipeline; 9 water suction pump; 10 drain pipe; 11 recovery vessel body; 12 oil storage tank; 13 telescopic tractor; 14 recovery device; 15 oil boom.

### DETAILED DESCRIPTION

In order to illustrate the technical solutions of the embodiments of the present disclosure more clearly, the following may briefly introduce the drawings that need to be used in the description of the embodiments. Obviously, the accompanying drawings in the following description are only some examples or embodiments of the present disclosure, for those ordinary skilled in the art, the present disclosure can also be applied to other similar scenarios according to these drawings without any creative effort. Unless obviously obtained from the context or the context illustrates otherwise, the same numeral in the drawings refers to the same structure or operation.

Unless the context illustrates specifically otherwise, the relative arrangements of components and steps, numerical expressions, and numerical values set forth in these embodiments do not limit the scope of the present disclosure. At the same time, it should be understood that, for the convenience of description, the sizes of the various parts shown in the drawings are not drawn according to the actual proportional relation. Techniques, methods, and devices known to those skilled in the art may not be discussed in detail, but in appropriate cases, the techniques, methods, and devices should be considered part of the authorized specification. In all embodiments shown and discussed herein, any specific values should be construed as exemplary only, and not as limitations. Therefore, other examples of exemplary embodiments may also include different values. It should be noted that numerals and letters denote similar items in the following figures, therefore, once an item is defined in one figure, it does not require further discussion in subsequent figures.

In the description of the present disclosure, it should be understood that the orientation or positional relations indicated by the terms “central”, “longitudinal”, “transverse”, “upper”, “lower”, “left”, “right”, “vertical”, “horizontal”, “top”, “peak”, “inner”, “outer”, etc. is the orientation or positional relations shown in the figures, which are only for the convenience of describing the present disclosure and simplifying the description, rather than indicating or implying that the device or element referred to must have a specific orientation, be constructed and operate for a specific orientation, and thus should not be construed as limiting the protection content of the present disclosure.

The flowcharts used in the present disclosure illustrate operations that system implement according to some embodiments of the present disclosure. It should be understood that the previous or subsequent operations may not be accurately implemented in order. Instead, each step may be processed in reverse order or simultaneously. Meanwhile, other operations may also be added to these processes, or a certain step or several steps may be removed from these processes.

In some embodiments, a recovery device may include a casing, a control center, a variable pressure airbag, a water suction pump, and a drain pipe. The casing is of a hollow structure, the hollow structure is used to accommodate an oil-water mixture and used as a temporary oil collection tank. The upper part of the casing is provided with an oil-water mixture inlet, the bottom of the casting is provided with a drain port, and the side wall of the casting is provided with an oil suction port. The variable pressure airbag is arranged outside the casing, and the variable pressure airbag is configured to adjust buoyancy of the recovery device. One end of the water suction pump is connected to the drain port, the other end of the water suction pump is connected to the drain pipe, and the water suction pump is configured to pump out water in the casing and discharge it to a water environment outside the casing through the drain pipe. The control center is arranged on the casing, and the control center is respectively connected to the variable pressure airbag and the water suction pump for controlling the volume of the variable pressure airbag and startup and shutdown of the water suction pump.

The casing may be configured to accommodate the oil-water mixture and used as the temporary oil collection tank. The shape of the casing may be an ellipsoid or a polyhedron similar to a sphere, which is not limited here.

In some embodiments, the wall of the casing may be configured as a hollow structure, and the hollow structure of the wall of the casing may be used for wiring for communication and connection between the control center and the water suction pump, the variable pressure airbag, and an oil discharge pump. The buoyancy of the recovery device may be further increased through a double hollow structure design inside and on the wall of the casing.

The oil-water mixture inlet refers to an inlet for absorbing the oil-water mixture in the external water environment. When the oil-water mixture inlet is located below a water surface of the external water environment, the oil-water mixture may enter a casing cavity of the recovery device from the oil-water mixture inlet. When the oil-water mixture inlet is located above the water surface of the external water environment, the oil-water mixture in the external water environment is no longer absorbed. A positional relation between the oil-water mixture inlet and the water surface of the external water environment may be adjusted by adjusting buoyancy of the casing. The buoyancy of the casing may be adjusted by the variable pressure airbag. Further descriptions regarding the variable pressure airbag may be found hereinafter.

In some embodiments, the oil-water mixture inlet may be provided with a filter. The filter may prevent sundries (such as water surface garbage, etc.) from entering the recovery device through the oil-water mixture inlet, causing a malfunction in an internal function of the recovery device.

In some embodiments, the oil-water mixture inlet is provided with a liquid level sensor, the liquid level sensor is communicatively connected with the control center and configured to detect location information (for example, a distance, etc.) of the water surface of the external water environment relative to the oil-water mixture inlet, and transmit the location information to the control center.

The drain port is configured to discharge water inside the casing to the external water environment. The drain port may be a through hole provided at the bottom of the casing. The water suction pump may be arranged at the drain port.

In some embodiments, one end of the water suction pump is connected to the drain port, the other end of the water suction pump is connected to the drain pipe, and the water suction pump is configured to pump out water in the casing and discharge the water to a water environment outside the casing through the drain pipe.

The oil suction port is configured to drain oil inside the casing into the recovery vessel. The oil suction port may be a through hole provided on the side wall of the casing. There may be one or more oil suction ports.

The variable pressure airbag is a component configured to adjust an internal pressure of the recovery device. In some embodiments, the variable pressure airbag may be configured to adjust the buoyancy of the recovery device. For example, the variable pressure airbag may supplement gas to the interior of the casing to increase the buoyancy and remove the gas inside the casing to reduce the buoyancy.

In some embodiments, the variable pressure airbag may be located outside the casing. The variable pressure airbag may be arranged at any position outside the casing. For example, the variable pressure airbag may be arranged at a position outside the middle of the casing. As another example, the variable pressure airbag may be arranged at a position outside the upper part of the casing. The description regarding the installation position of the variable pressure airbag is just an exemplary description and does not constitute a limitation to the implementation.

In some embodiments, the recovery device further includes an airbag support frame, the airbag support frame is arranged outside the casing, and the airbag support frame is configured to support the variable pressure airbag and fix the variable pressure airbag outside the casing.

In some embodiments, the variable pressure airbag is fixed with the airbag support frame by glue and screws, and the airbag support frame is connected to the casing by welding. The connection method is only an exemplary description and does not constitute a limitation to the implementation method.

In some embodiments, the control center may be located on the casing. The control center is communicatively connected with the variable pressure airbag and the water suction pump respectively.

In some embodiments, the control center may control volume of the variable pressure airbag and the startup and shutdown of the water suction pump according to instructions of operators. Further descriptions regarding controlling the variable pressure airbag and the water suction pump may be found hereinafter.

In some embodiments, the recovery device may further include at least two fixed columns, which may be configured to support and connect the control center. One end of each of the fixed columns may be arranged on the casing, and the other end of each of the fixed columns is connected to the control center. The fixed columns may have many forms. For example, cylindrical shapes, etc., which is not limited here.

In some embodiments, the fixed columns may be arranged on the casing around the oil-water mixture inlet, and the control center is arranged overhead on the upper part of the oil-water mixture inlet through the fixed columns.

In some embodiments, the filter arranged at the oil-water mixture inlet may cover the outside of the fixed columns. With this arrangement, the control center may be raised to increase inflow amount of the mixed oil-water inlet, and at the same time, the fixed columns may support and tension the filter.

In some embodiments, the recovery device further includes an oil detector and an isolation layer. The isolation layer is arranged inside the casing, which is used for water penetration and oil separation. The oil detector is arranged on the inner wall of the casing, which is used to detect a position of an oil level; and when the oil level touches the oil detector, the oil detector may send a detection result to the control center. The control center is communicatively connected with the oil detector, which is configured to control the volume of the variable pressure airbag and the startup and shutdown of the water suction pump according to the detection result of the oil detector.

The isolation layer may be configured for water penetration and oil separation, that is, water may pass through the isolation layer, while oil cannot pass through the isolation layer. The isolation layer may be arranged inside the casing. For example, the isolation layer may be arranged in a central region inside the casing. As another example, the isolation layer may be arranged near the oil suction port inside the casing. The isolation layer may also be arranged at other positions inside the casing according to requirements, which are not limited here.

In some embodiments, the isolation layer may include a hydrophilic-oleophobic membrane and rigid filters disposed on the upper portion and lower portion of the hydrophilic-oleophobic membrane. The hydrophilic-oleophobic membrane may be configured to separate water and oil, and the hydrophilic-oleophobic membrane may be composed of materials that keep water close and oil away.

In some embodiments, the rigid filters may be a stainless steel mesh. In some embodiments, the rigid filters may also be made of other materials with a certain hardness. The description regarding the materials of the rigid filters is just an exemplary description and does not constitute a limitation to the implementation. By setting the rigid filters, bearing capacity of the isolation layer may be improved, the hydrophilic-oleophobic membrane may be protected, and deformation of the hydrophilic-oleophobic membrane may be prevented due to massive oil collection.

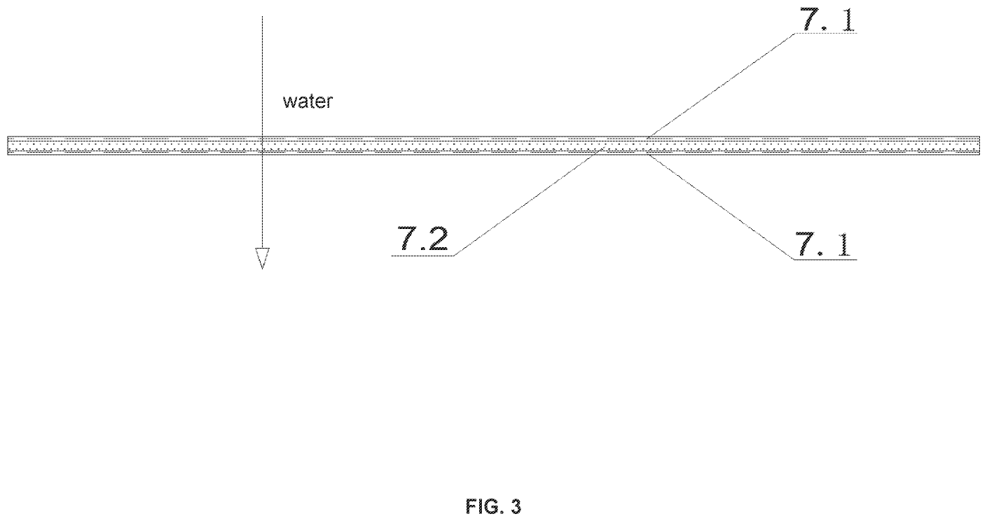

Some of the following embodiments may be understood with reference to FIG. 3, but the figures are only schematic representations of some of the implementations and do not constitute a limitation to the implementations. As shown in FIG. 3, in some embodiments, the isolation layer 7 includes a hydrophilic-oleophobic membrane 7.2 and rigid filters 7.1 disposed on the upper portion and the lower portion of the hydrophilic-oleophobic membrane. A water-permeable direction of the hydrophilic-oleophobic membrane 7.2 is that water flows in the direction of an arrow.

In some embodiments, the isolation layer may also be of other structures capable of separating water and oil, which is not limited here.

By setting the isolation layer in the inner cavity of the casing, oil, and water in the oil-water mixture may be separated, and the oil is temporarily stored above the isolation layer, which is convenient for subsequent oil discharge from the inside of the casing through the oil suction port. This has a good and stable oil recovery effect, improves the oil collection efficiency, and can quickly and stably respond to offshore oil-spilling operations.

The oil detector may be configured to detect an oil condition inside the casing. In some embodiments, the oil detector may be configured to detect a position of an oil level, and when the oil level touches the oil detector, the oil detector may send a detection result to the control center. Descriptions regarding the control center may be found hereinafter.

In some embodiments, the oil detector may be arranged on the inner wall of the casing. For example, the oil detector may be arranged above the isolation layer, and may also be arranged at other positions on the inner wall of the casing according to requirements, which is not limited here.

In some embodiments, the oil detector includes a first oil detector and a second oil detector, and a height of the first oil detector on the inner wall of the casing is higher than that of the second oil detector. The second oil detector is arranged at a connection between the isolation layer and the inner wall of the casing.

The function of the first oil detector is to feed back to the control center when oil is detected. The control center controls the variable pressure airbag to make the recovery device rise above the water surface, the oil mixture inlet is higher than the water surface, and the oil-water mixture in the external water environment is no longer absorbed.

The function of the second oil detector is to detect oil after the water suction pump pumps out the water remaining at the bottom and then feeds back to the control center.

In some embodiments, the first oil detector and the second oil detector are arranged at the lower position inside the casing.

The operating principle of the first oil detector and the second oil detector is that the oil-water mixture gradually enters the inner cavity of the casing of the recovery device from the oil-water mixture inlet, when the first oil detector detects oil, indicating that spilled oil recovered is almost filling the entire cavity of the casing. In order to prevent the oil-water mixture from continuing to enter to cause a secondary oil-spilling, a variable pressure airbag control room sends an instruction of inflation and pressurization to the variable pressure airbag, and the variable pressure airbag is inflated and pressurized to increase the buoyancy of the recovery device. The oil-water mixture inlet is higher than the water surface of the water environment outside the casing, making the oil-water mixture no longer enter the oil-water mixture inlet. During this process, the water suction pump continues to work to discharge water inside the casing. When the internal oil level touches the second oil detector, it means that the water inside the casing is basically drained. A water suction pump control room may control the water suction pump to stop working immediately, or stop working after the water suction pump continues to work for a preset time, so as to ensure that the water inside the casing is drained as much as possible to obtain spilled oil with lower water content.

In other embodiments, only one oil detector may be arranged. For example, one oil detector may be arranged only at the position of the first oil detector (which cannot be arranged at the position of the second oil detector because it may cause a secondary oil-spilling). When only one oil detector is arranged, the steps for usage are as follows: the oil detector detects the oil level and feeds back to the control center, the control center sends an instruction of increasing volume of the pressure variable airbag until the oil-water mixture inlet is higher than the water surface, after the oil-water mixture inlet is higher than the water surface, the control center sends an instruction to the suction pump to stop working after a delay of N minutes, and after N minutes, and starts the oil discharge pump to transport oil recovered in the inner cavity of the casing to the recovery vessel body.

In some embodiments, the recovery device further includes an oil discharge pump and an oil suction pipeline. The oil discharge pump may be arranged on the isolation layer, one end of the oil suction pipeline is connected to the oil discharge pump, after passing through the oil discharge port, the other end of the oil suction pipeline is connected to the recovery vessel recovering the spilled oil. The oil discharge pump is configured to discharge oil collected in the casing to the recovery vessel through the oil suction pipeline.

In some embodiments, the control center may also be communicatively connected with the oil discharge pump, and the control center may be configured to control the startup and shutdown of the oil discharge pump.

In some embodiments, the control center may include a water suction pump control room, a variable pressure airbag control room, and an oil discharge pump control room arranged in parallel. The water suction pump control room is communicatively connected with the water suction pump to control the startup and shutdown of the water suction pump. The variable pressure airbag control room may be communicatively connected with the variable pressure airbag to control the volume of the variable pressure airbag. The oil discharge pump control room may be communicatively connected with the oil discharge pump to control the startup and shutdown of the oil discharge pump. As an example only, the control center may send an instruction to change the volume of the airbag to the variable pressure airbag, an instruction to open and close the water suction pump to the water suction pump, and an instruction to open and close the oil discharge pump to the oil discharge pump according to detection result data from the oil detector and instructions of operators.

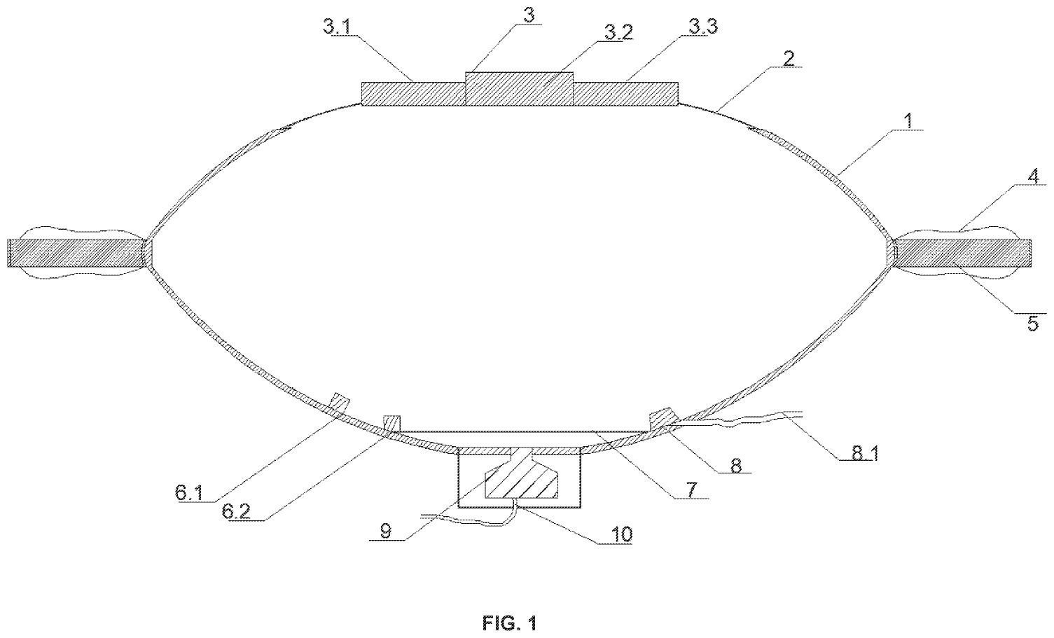

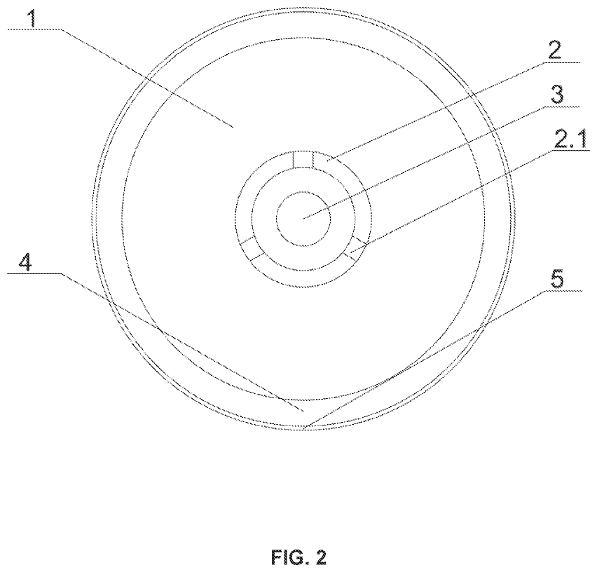

The following embodiments may be understood with reference to FIG. 1 and FIG. 2, but the figures are only schematic representations of some of the implementations and do not constitute a limitation to the implementations.

As shown in FIG. 1 and FIG. 2, in some embodiments, an oil-water mixture inlet 2 is arranged on the upper part of the casing 1 of the recovery device; a water suction pump 9 is arranged at the drain port of the bottom of the casing 1, one end of the water suction pump 9 is connected to the drain port, and the other end of the water suction pump 9 is connected to the drain pipe 10; the water suction pump 9 pumps out the water in the casing 1 and discharges it to the water environment outside the casing through the drain pipe 10. The side wall of the casing 1 is provided with an oil suction port, the oil suction pipeline 8.1 passes through the oil suction port, one end of the oil suction pipeline 8.1 is connected to the oil discharge pump 8 (which is arranged inside the casing 1), and the other end of the oil suction pipeline 8.1 is connected to the recovery vessel. An isolation layer 7 is arranged inside the casing 1, and the oil discharge pump 8 is arranged on the upper part of the isolation layer 7. An oil detector is arranged on the inner wall of the casing 1, when an oil surface touches the oil detector, the oil detector may send a detection result to the control center 3. A variable pressure airbag 4 is arranged outside the casing 1, and the variable pressure airbag 4 may be fixedly arranged on the outside of the casing 1 through the airbag support frame 5. The control center 3 is arranged on the casing 1, and the control center 3 may be arranged overhead on the upper part of the oil-water mixture inlet 2 through fixed columns 2.1. The fixed columns 2.1 are configured to support and connect the control center 3, one end of which is arranged on the casing 1, and the other end of which is connected to the control center 3.

The recovery device of the present disclosure utilizes the physical properties of oil and water and adopts a mechanical recovery method, which allows the physical and chemical properties of oil not to change, has a simple design structure and convenient operation, so the efficiency of oil recovery operation can be effectively improved.

In some embodiments, the recovery device may include a driving component. The drive component may be configured to control the movement of the recovery device. The driving component may include a water suction pipe, a water outlet pipe, a backup water outlet pipe, a water pump, and a connecting shaft. Electric control valves are arranged in the water outlet pipe and the backup water outlet pipe. One end of the water suction pipe may be connected to the water pump, the other end of the water suction pipe may be connected to the water outlet pipe and the backup water outlet pipe, and the other end of the water suction pipe is connected to the bottom of the casing through the connecting shaft. The water pump may be configured to suck water in a water environment outside the casing into the water suction pipe, and discharge water through the water outlet pipe and/or the backup water outlet pipe. The control center may be communicatively connected with the electric control valves for controlling startup and shutdown of the water outlet pipe and the backup water outlet pipe.

In some embodiments, when the water outlet pipe is functioning properly, the control center may control the backup water outlet pipe to close. When the water outlet pipe malfunctions (e.g., in a blocked state), the control center may control the backup water outlet pipe to start.

In some embodiments, there may include a plurality of water outlet pipes and backup water outlet pipes. Preferably, two water outlet pipes and one backup water outlet pipe may be set, and each water outlet pipe is arranged at equal intervals (e.g., the angle between adjacent water outlet pipes being 120°). The water outlet pipes are evenly arranged at a drain end of the water suction pipe, which may better balance the device, and the recovery device may be more stable when two drain pipes discharge at a certain angle simultaneously. In some embodiments, other counts of the water outlet pipes and the backup water outlet pipes may also be provided, without limitation here.

Under the action of the water pump, the water suction pipe may suck water in the external water environment into the pipe, and discharge water into the external water environment through the water outlet pipe and/or the backup water outlet pipe, providing power for the recovery device to move forward. The electric control valves, the startup/shutdown of the water pump, and the power of the water pump may be controlled by the control center.

In some embodiments, the water pump may be arranged at an inlet end of the water suction pipe, and the water outlet pipe and the backup water outlet pipe may be arranged around the drain end of the water suction pipe. The inlet end is an end of the water suction pipe extending into the external water environment, and the drain end is an end of the water suction pipe close to the water surface.

In some embodiments, the drain end of the water suction pipe may be connected to the bottom of the casing of the recovery device through a connecting shaft, and the connecting shaft may be connected to the drain end of the water suction pipe, wherein connection methods include but are not limited to a threaded connection, a detachable connection, etc.

In some embodiments, the control center may control the rotation of the connecting shaft, and the rotation of the connecting shaft may drive the water suction pipe to rotate to drive the water outlet pipe and the backup water outlet pipe to rotate, so as to control a forward direction of the recovery device.

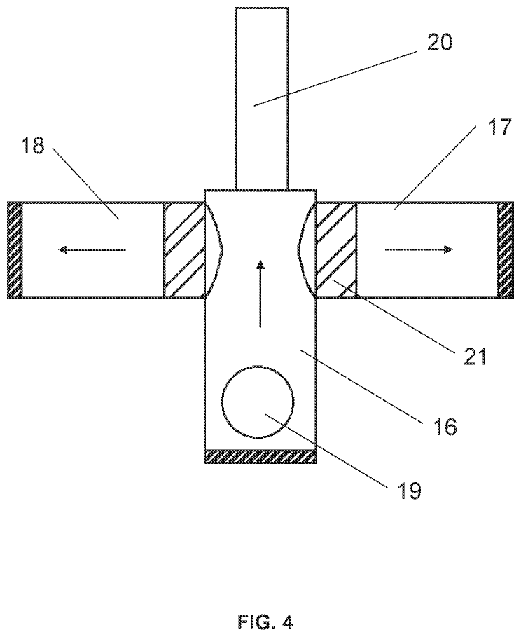

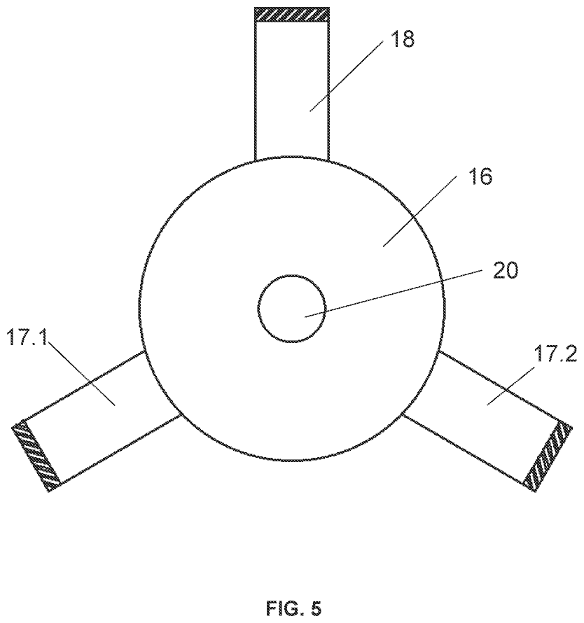

The following embodiments may be understood with reference to FIG. 4 and FIG. 5, but the figures are only schematic representations of some of the implementations and do not constitute a limitation to the implementations.

As shown in FIG. 4, in some embodiments, one end of the water suction pipe 16 may be connected to the water pump 19, the other end of the water suction pipe 16 may be connected to the water outlet pipe 17 and the backup water outlet pipe 18, and the other end of the water suction pipe 16 may be connected to the bottom of the casing through the connecting shaft 20. The electric control valves 21 may be arranged in the water outlet pipe 17 and the backup water outlet pipe 18.

As shown in FIG. 5, when two water outlet pipes (including a first water outlet pipe 17.1 and a second water outlet pipe 17.2) and one backup water outlet pipe 18 are arranged, each of the water outlet pipes is arranged at equal intervals.

Some embodiments of the present disclosure also provide a recovery vessel for oil spilling on water, including a recovery vessel body and a recovery device. The recovery vessel body may be provided with an oil storage tank and an oil boom. The oil storage tank may be configured to store spilled oil recovered by the recovery device; the oil boom may be configured to enclose the oil-spilling water area to prevent the oil spill from spreading again.

In some embodiments, the recovery vessel also includes a telescopic tractor. The telescopic tractor is arranged on the recovery vessel body, a free end of which is connected to the recovery device, and the telescopic tractor is configured to adjust a position of the recovery device.

In some embodiments, a telescopic tractor may be configured to place the recovery device in the oil-spilling area and tow the recovery device to the recovery vessel body or a shore station.

In some embodiments, the recovery vessel also includes a control system. The control system may be configured to adjust the position of at least one recovery device. For example, the control system may control the placement and recovery of at least one recovery device.

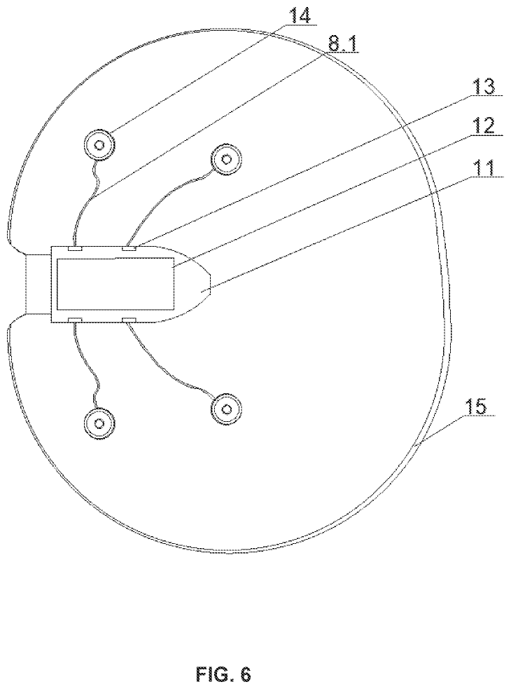

The following embodiments may be understood with reference to FIG. 6, but the figures are only schematic representations of some of the implementations and do not constitute a limitation to the implementations.

As shown in FIG. 6, in some embodiments, the recovery vessel includes a recovery vessel body 11 and a recovery device 14, and the recovery vessel body 11 includes an oil storage tank 12 and an oil boom 15.

In some embodiments, the oil storage tank 12 is connected to the oil discharge pump 8 of the recovery device 14 through an oil discharge pipe 8.1. In some embodiments, the oil storage tank 12 is arranged in the cabin of the recovery vessel, and the oil boom 15 is arranged in the stern of the recovery vessel.

In some embodiments, the telescopic tractor 13 is arranged on the recovery vessel body 11, a free end of which is connected to the recovery device 14. When placing the recovery device 14, the telescopic tractor 13 may place the recovery device 14 in the oil-spilling area; after spilled oil recovery is completed, the telescopic tractor 13 may tow the recovery device 14 to the recovery vessel body 11 or the shore station.

The recovery device and the recovery vessel in the present disclosure may cooperate with the recovery vessel body to carry out continuous and uninterrupted recovery of spilled oil on the water surface in the oil-spilling water area until the spilled oil is cleared, which further improves the work efficiency of oil recovery and the spilled oil recovery efficiency, realizing rapid control and restoration of the ecological environment, and solving the problem that the oil recovery devices equipped on most oil recovery vessels cannot continuously recover in the oil-spilling water area.

During the process of spilled oil recovery, the recovery vessel of the present disclosure cooperates with the oil boom of the oil recovery vessel to recover the spilled oil in sequence, and the spilled oil may be controlled not to disperse further outward so that the recovery efficiency of the spilled oil is improved.

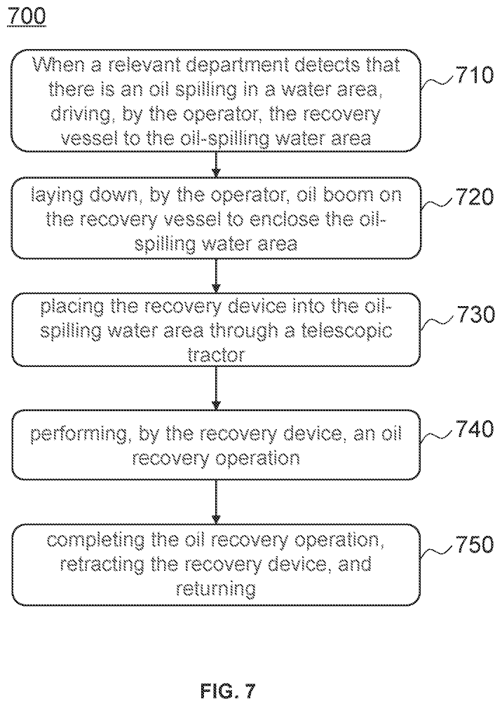

FIG. 7 is a flowchart illustrating an exemplary process of recovery vessel operations according to some embodiments of the present disclosure. As shown in FIG. 7, operating process of the recovery vessel of the present disclosure is as follows.

In step 710, when a relevant department detects that there is oil spilling in a water area, driving, by the operator, the recovery vessel to the oil-spilling water area.

In step 720, laying down, by the operator, oil boom on the recovery vessel to enclose the oil-spilling water area.

In step 730, placing the recovery device into the oil-spilling water area through a telescopic tractor.

In step 740, performing, by the recovery device, an oil recovery operation. The oil recovery operation includes the following steps S1-S6.
Step S1: an airbag control room sends an inflation command to a variable pressure airbag, and the variable pressure airbag is inflated to make the recovery device float in the water, causing an oil-water mixture inlet to be slightly lower than the water surface of the external water environment, and the oil-water mixture to enter the inner cavity of the casing from the oil-water mixture inlet;
Step S2: a water suction pump control room sends an opening instruction to a water suction pump, and the water suction pump discharges the water in the inner cavity of the casing through a drain pipe to the outside of the casing, providing power for the oil-water mixture on the water surface to flow into the recovery device;
Step S3: since the density of oil is generally less than that of water, the oil is always on the water when the oil-water mixture enters the recovery device. When the first oil detector detects oil, the airbag control room sends an inflation command to the variable pressure airbag, the variable pressure airbag is inflated and pressurized, and then buoyancy of the recovery device increases until the oil-water mixture inlet is higher than the water surface;
Step S4: the water suction pump continues to work, and the water inside the casing continues to be discharged. When the internal oil level touches a second oil detector, it means that the water inside the casing is drained through the hydrophilic-oleophobic membrane. The water suction pump control room may control the water suction pump to stop working immediately, or stop working after the water suction pump continues to work for a preset time, so as to ensure that the water inside the casing is drained as much as possible to obtain spilled oil with lower water content;
Step S5: the oil discharge control room sends an opening command to an oil discharge pump, and the oil discharge pump works to discharge the oil collected inside the casing to an oil storage tank on the recovery vessel body through an oil discharge pipe;
Step S6: when the second oil detector fails to detect the oil level, it means that the oil discharge is over, and the second oil detector sends a detection result to the airbag control room, and the airbag control room sends an instruction to the variable pressure airbag to deflate and reduce volume, causing the recovery device to gradually sink until the oil-water mixture inlet is lower than the water surface, and a new round of oil recovery operation is started, and the above operations are repeated until spilled oil inside oil boom is completely recovered.

In step 750, completing the oil recovery operation, retracting the recovery device, and returning.

The recovery device of the present disclosure may also directly carry out a spilled oil recovery operation in a fixed manner. During the process of spilled oil recovery, the spilled oil can be sustainably recovered without the need for the operator to issue instructions, which does not need a large amount of manpower and material resources. The recovery device may automatically perform recovery operation only by placing a spilled oil recovery device in the oil-spilling water area, which effectively reduces the use of labor and improves the operation efficiency of the spilled oil recovery.

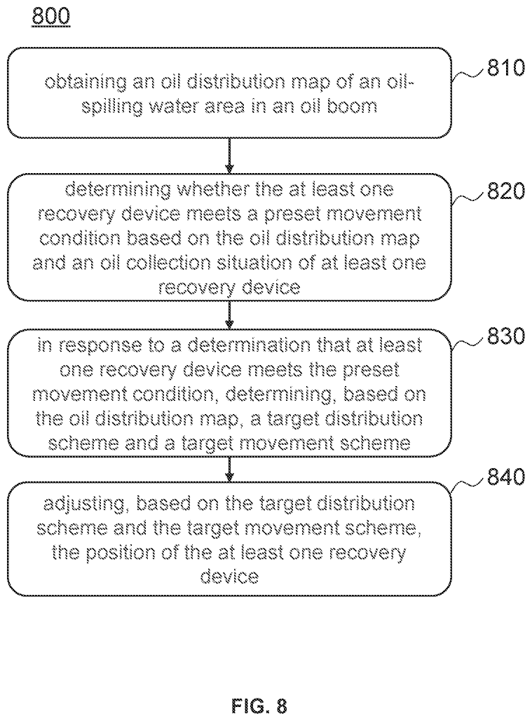

The embodiment of the present disclosure also discloses a control method for a recovery device for oil spilling on water. FIG. 8 is a flowchart illustrating an exemplary process of a control method for a recovery device according to some embodiments of the present disclosure. In some embodiments, the process 800 may be performed by a control system of a recovery vessel. As shown in FIG. 8, the process 800 includes the following steps.

In step 810, obtaining an oil distribution map of an oil-spilling water area in an oil boom.

The oil distribution map refers to a distribution map of spilled oil in the oil boom.

The oil distribution map may be obtained by monitoring the position of oil in the oil-spilling water area in the oil boom. For example, by setting a combination of a telescopic pole and a camera on the recovery vessel, or using devices such as drones, etc. to take images of the oil-spilling water area in the oil boom, the oil distribution map may be obtained by recognizing the images.

In some embodiments, a control system may re-acquire the oil distribution map in the oil-spilling water area after at least one recovery device of the recovery vessel completes a round of spilled oil recovery. After the recovery device is filled with oil, the telescopic tractor may be manually pulled or controlled by the control system to pull the recovery device to the recovery vessel body for oil discharge. After the oil discharge is completed, a round of spilled oil recovery is completed. During the process of pulling the recovery device to the recovery vessel body by the telescopic tractor, since the movement of the recovery device may change oil distribution in the oil-spilling area, therefore, the oil distribution map in the oil-spilling water area may be re-acquired after completing a round of spilled oil recovery, avoiding an adverse effect of oil distribution changes on following recovery work.

In step 820, determining whether at least one recovery device meets a preset movement condition based on the oil distribution map and an oil collection situation of at least one recovery device.

The oil collection situation may include whether the device is fully filled with oil.

In some embodiments, the preset movement condition includes at least one of the following: the recovery of oil within a certain distance of the recovery device being completed, the recovery device not continuing to work, etc. The recovery device not continuing to work includes situations such as the recovery device being filled with oil, the recovery device malfunctioning, etc.

In some embodiments, the preset movement condition may also include other forms, without limitation thereto.

In some embodiments, the control system may determine whether the recovery device meets the preset movement conditions in various ways. For example, the control system may determine whether the recovery of oil within a certain distance of the recovery device is completed based on the oil distribution map, and determine that the recovery device meets the preset movement condition in response to the recovery being completed. As another example, the control system may determine that the recovery device meets the preset movement condition in response to the oil collection situation of the recovery device being filled with oil.

In step 830, in response to a determination that the at least one recovery device meets the preset movement condition, determining, based on the oil distribution map, a target distribution scheme and a target movement scheme.

A distribution scheme includes a distribution position of each recovery device in the oil boom. The distribution position may be a position of a sub-area where the recovery device needs to be arranged when the oil-spilling area is divided into a plurality of sub-areas. The target distribution scheme may be a distribution scheme determined according to a current oil distribution map.

In some embodiments, the recovery device may be arranged at the starting position in the sub-area. The recovery device may move from the starting point according to a certain movement rule to recover spilled oil. The movement rule may be preset by the system or manually. The starting point may be a center point of the sub-area, or other points, which may be set according to actual needs.

In some embodiments, there may be a plurality of ways to divide the oil-spilling area. For example, a circumscribed rectangle of the oil distribution map may be determined, and the circumscribed rectangle may be divided into a plurality of sub-areas of preset shapes. The shape of the area enclosed by the oil boom is uneasy to change. Therefore, it is stable and reasonable for a division of the sub-areas to determine the circumscribed rectangle through the oil distribution map and divide the circumscribed rectangle into multiple sub-areas of preset shapes.

In some embodiments, the distribution scheme of the recovery device may be represented by a matrix, and the matrix may include D elements, where D corresponds to the count of the sub-areas. An exemplary distribution scheme may be (M₁, M₂, . . . , M_{D}), wherein M₁, M₂, . . . , M_{D} respectively represent corresponding distribution positions (i.e., sub-areas) of recovery devices 1˜n, and n represents the count of the recovery devices.

A movement scheme is a scheme for moving a recovery device from its current position to another position.

In some embodiments, the movement scheme may include an adjustment angle, a movement distance, and water pump power of at least one recovery device.

The adjustment angle refers to an angle at which a movement direction of the recovery device is adjusted. Preferably, the adjustment angle may be an angle between the water outlet pipe closed by electric control valves (i.e., an unused water outlet pipe) and the movement direction. When the driving component of the recovery device includes two water outlet pipes and a backup water outlet pipe, and their respective included angles are 120°, the adjustment angle of the recovery device may be determined as an angle corresponding to the angle of adjusting a drain direction of the backup water outlet pipe to be in line with the target movement direction. When the recovery device moves from its current position to another position at a slower speed, the oil distribution may change as the recovery device moves. Therefore, considering the adjustment angle of the recovery device may more accurately obtain the oil distribution.

The target movement scheme refers to a movement scheme for moving at least one recovery device in the recovery vessel from the current position to a corresponding distribution position in the target distribution scheme.

The target distribution scheme and target movement scheme may be determined in a plurality of ways. In some embodiments, the target distribution scheme and the target movement scheme may be determined based on human experience or historical data.

In some embodiments, the control system may determine the target distribution scheme and the target movement scheme through a preset algorithm based on the oil distribution map.

An exemplary preset algorithm may include: generating at least one candidate position scheme for at least one recovery device based on current oil distribution parameters; carrying out multiple rounds of iterative updates on the at least one candidate position scheme until a preset condition is met, and determining a target position scheme; and determining the target distribution scheme and a plurality of corresponding target movement schemes based on the target position scheme.

The oil distribution parameters may include an oil coverage rate corresponding to each sub-area in the oil-spilling area. The oil distribution parameters may be represented by a matrix, a count of elements in the matrix represents a count of sub-areas, and a value of an element represents the oil coverage rate of oil in a corresponding sub-area. The oil coverage rate may be determined by a ratio of oil coverage area to total area of sub-areas. In some embodiments, the oil coverage rate may be represented by a grade. A corresponding relationship between the grade and the oil coverage rate may be obtained through system presetting, human presetting, etc. Exemplarily, current oil distribution parameters may be (h, i, j), indicating that an oil coverage rate of a sub-area 1 is h, an oil coverage rate of a sub-area 2 is i, and an oil coverage rate of a sub-area 3 is j.

The current oil distribution parameters may be determined in a plurality of ways. In some embodiments, the control system may determine the current oil distribution parameters by analyzing and processing the oil distribution map. In some embodiments, the control system may also process an oil distribution image through a machine learning model to determine the current oil distribution parameters. Further descriptions regarding determining the current oil distribution parameters through a machine learning model may be found hereinafter.

The candidate position scheme may include a plurality of sub-areas where recovery devices need to be located. A specific corresponding relationship between the recovery devices and the sub-areas in the candidate position scheme is unknown. The candidate position scheme may be represented by a matrix, and the matrix may include D elements, where D corresponds to a count of sub-areas. For example, the candidate position scheme may be (X₁, X₂, . . . , X_{D}), where X₁, X₂, . . . , X_{D} represent different sub-areas, respectively.

The control system may generate the candidate position scheme in a plurality of ways based on the current oil distribution parameters.

In some embodiments, the control system may be generated by random methods. For example, an initial candidate position scheme may be randomly generated as (X⁰₁, X⁰₂, . . . , X⁰_{D}), etc., wherein 0 is an identifier (representing the 0th iteration, i.e., an initial value that has not yet started iteration). An updated candidate position scheme obtained in the previous round may be taken as an object of the next round of iterative update.

In some embodiments, the control system may determine the candidate position scheme based on oil coverage rates and coverage rate thresholds for each sub-area in the oil-spilling area. At least one sub-area whose oil coverage rate exceeds a coverage threshold is determined as the candidate position scheme.

In some embodiments, at least one round of multiple rounds of iterative updates on the candidate position scheme includes: for at least one candidate position scheme, updating corresponding adjustment parameters based on a relationship between the candidate position scheme and a historical optimal solution; updating the candidate position scheme based on updated adjustment parameters.

In some embodiments, the control system may obtain a plurality of updated candidate position schemes after multiple rounds of iterations based on a plurality of candidate position schemes. In some embodiments, the control system may also determine the target position scheme by comparing evaluation values of the plurality of updated candidate position schemes. For example, the candidate position scheme with the highest evaluation value may be taken as the target position scheme. Further descriptions regarding the evaluation values may be found in the related description hereinafter.

In some embodiments, in at least one round of iteration, for at least one of the plurality of candidate position schemes, adjustment parameters of the candidate position scheme may be updated to obtain updated adjustment parameters; and the candidate position scheme may be updated based on the updated adjustment parameters.

The adjustment parameters refer to an updating range of each distribution position in the candidate position scheme. For example, the adjustment parameters may adjust a certain distribution position in the candidate position scheme from a sub-area a to a sub-area b. There may be a plurality of adjustment parameters, and the plurality of adjustment parameters may be in one-to-one correspondence with a plurality of candidate position schemes. The adjustment parameters may include a plurality of adjustment elements. The plurality of adjustment elements may be in one-to-one correspondence with each distribution position in the candidate position scheme. When a dimension of the candidate position scheme is D, corresponding adjustment parameters may be expressed as (vⁱ₁, vⁱ₂, . . . , vⁱ_{d}), 1≤d≤D wherein vid denotes an adjustment element determined in the i-th round of iteration to adjust distribution position d.

In some embodiments, the control system updates the candidate position scheme based on the updated adjustment parameters, comprising: iteratively updating each candidate position scheme based on the adjustment parameters corresponding to each candidate position scheme. For example, the adjustment elements may be added to an original distribution position to obtain the updated distribution position (e.g., obtaining a sub-area number of the distribution position, etc.), i.e., the updated adjustment parameters may be determined by formula (1):

X_{id}^{k+1}=X_{id}^{k}+V_{id}^{k+1} (1)

where X_{id}^{k+1} denotes an updated distribution position of a sub-area d in an i-th candidate position scheme after a (k+1)-th round of iteration, and X_{id}^{k} denotes an updated distribution position of the sub-area d in the i-th candidate position scheme after a k-th round of iteration, V_{id}^{k+1} denotes adjustment elements of the sub-area d in the i-th candidate position scheme updated after the (k+1)-th round of iteration.

In some embodiments, for at least one of the multiple rounds of iterative updates, the control system may update the adjustment parameters based on the relationship between the candidate position scheme and the historical optimal solution. For example, if a difference value between the candidate position scheme and the historical optimal solution is small, a corresponding adjustment parameter is small; on the contrary, the corresponding adjustment parameter is large. In some embodiments, initial values of adjustment parameters corresponding to a plurality of candidate position schemes may be the same or different. Initial adjustment parameters may be generated in a random manner.

In some embodiments, the control system may determine whether an iteration ending condition is met in each round of iteration; and in response to a determination that the iteration ending condition is met, stop multiple rounds of iterations to obtain a target position scheme. The iteration ending condition may be determined according to actual needs. In some embodiments, the iteration ending condition may include that the evaluation values meet the needs, the evaluation values converge, the iterations are completed for specified times, etc.

In some embodiments, for a certain candidate position scheme (for example, the i-th candidate position scheme), the historical optimal solution includes an individual optimal solution corresponding to the i-th candidate position scheme, and a group optimal solution commonly corresponding to a plurality of candidate position schemes. The group optimal solution corresponding to the plurality of candidate position schemes is the same, but the individual optimal solution is different.

The individual optimal solution may refer to an optimal updated candidate position scheme among multiple updated candidate position schemes corresponding to an i-th candidate position scheme as of a current round of the iterative update. For example, as of a k-th round of iteration, the individual optimal solution corresponding to the i-th candidate position scheme may be an optimal updated candidate position scheme among all updated candidate position schemes of the i-th candidate position scheme in each iteration of multiple historical iterations before the k-th round of iteration.

The group optimal solution refers to an optimal candidate position scheme among all the updated candidate position schemes corresponding to the plurality of candidate position schemes as of a current round of the iterative update. For example, as of the k-th round of iteration, the group optimal solution may be an optimal updated candidate position scheme among all the updated candidate position schemes in each of the multiple rounds of historical iterations before the k-th round of iteration. The optimal candidate position scheme refers to a candidate position scheme with the highest evaluation value among the plurality of candidate position schemes. Descriptions regarding the evaluation values may be found hereinafter.

In some embodiments, for adjustment parameters corresponding to a certain candidate position scheme, a certain adjustment element in the adjustment parameters is updated based on the following formula: updated adjustment element=weight 1*adjustment element to be updated+weight 2×first difference value+weight 3×second difference value. The first difference value corresponds to a difference value between the candidate position scheme and its corresponding individual optimal solution; the second difference value corresponds to a difference value between the candidate position scheme and the group optimal solution. Weight 1, weight 2, and weight 3 may be preset, or determined in other ways, for example, which are determined based on algorithms such as regression analysis, etc.

In some embodiments, an evaluation algorithm for determining the historical optimal solution may include: for each candidate position scheme, determining, by the control system, predicted oil distribution parameters after a preset time based on an evaluation model; determining recovery efficiency based on the predicted oil distribution parameters; and determining the evaluation value based on the recovery efficiency.

The predicted oil distribution parameters refer to oil distribution parameters in the oil boom after a round of spilled oil recovery according to a candidate distribution scheme and a candidate movement scheme corresponding to the candidate position scheme.

The evaluation model may be a machine learning model. In some embodiments, the evaluation model may be a machine learning model with a custom structure hereinafter. The evaluation model may also be a machine learning model of other structures, such as a neural network model, etc.

In some embodiments, the evaluation model includes a feature extraction layer and a distribution prediction layer. An input of the feature extraction layer is a current oil distribution map, and an output of the feature extraction layer is current oil distribution parameters. The input of the distribution prediction layer is current oil distribution parameters, current wind speed sensor readings, a candidate distribution scheme corresponding to the candidate position scheme, a candidate movement scheme corresponding to the candidate position scheme, and environmental data, and the output of the distribution prediction layer is the predicted oil distribution parameters. The environmental data may include a water body temperature and a water flow velocity. The environmental data may be acquired by corresponding sensors. Further descriptions regarding the current oil distribution map and current oil distribution parameters may be found hereinabove.

The candidate distribution scheme is a distribution scheme determined according to the candidate position scheme, and the candidate movement scheme is the movement scheme determined according to the candidate distribution scheme.

In some embodiments, the control system may determine at least one candidate distribution scheme in a plurality of ways based on at least one candidate position scheme. For example, for each candidate position scheme in the at least one candidate position scheme, the control system may randomly match multiple recovery devices with multiple sub-areas in the candidate position scheme to determine a corresponding candidate distribution scheme.

In some embodiments, for each of the at least one candidate position scheme, the control system may determine at least one initial distribution scheme based on the candidate position scheme; determine sums of movement distances of all recovery devices from the current position to corresponding sub-areas in each initial distribution scheme; and determine an initial distribution scheme corresponding to a minimum sum of movement distances among the sums of movement distances corresponding to at least one initial distribution scheme as a candidate distribution scheme. A manner of determining the initial distribution scheme may be the manner of randomly matching hereinabove.

In some embodiments of the present disclosure, a plurality of initial distribution schemes are randomly generated, and the initial distribution scheme with the smallest sum of movement distances is selected as the initial distribution scheme, which may reduce computation and save computing resources.

In some embodiments, for each candidate distribution scheme, the control system may generate a plurality of corresponding candidate movement schemes in various ways based on the candidate distribution scheme.

In some embodiments, the control system may determine a movement direction of each recovery device according to a current distribution scheme and a candidate distribution scheme of at least one recovery device in the recovery vessel; and determine an adjustment angle of a corresponding recovery device based on the movement direction. The movement direction refers to a forward direction of the recovery device. In some embodiments, the control system may determine an angle between a water outlet pipe in which an electric control valve is closed (i.e., an unused water outlet pipe) and the movement direction as the adjustment angle.

In some embodiments, the control system may determine a movement distance of the recovery device based on distances between current positions of at least one recovery device and each distribution position in the candidate distribution scheme (e.g., a central position of a sub-area).

In some embodiments, the control system may also determine the water pump power of the recovery device based on a preset rule and the current oil distribution map. For example, the preset rule may be to choose a relatively small water pump power in an area where the oil coverage rate is relatively high. When arranging the recovery device, adjusting the water pump power of the recovery device according to the oil coverage rate may avoid a change of oil distribution caused by large water pump power, which may affect follow-up spilled oil recovery work.

It should be noted that, for one candidate distribution scheme, a plurality of candidate movement schemes may be determined. The water pump power of recovery devices is different in the plurality of candidate movement schemes while the movement distances and adjustment angles of the recovery devices are the same.

In some embodiments, the feature extraction layer may be a model such as CNN, etc. and the distribution prediction layer may be a model such as NN, etc. In some embodiments, the output of the feature extraction layer may be the input of the distribution prediction layer, and the feature extraction layer and the distribution prediction layer may be jointly trained.

In some embodiments, a training sample used for joint training may include a sample oil distribution map, a sample wind speed sensor reading, a candidate distribution scheme corresponding to a sample candidate position scheme, a candidate movement scheme corresponding to the sample candidate position scheme, and sample environmental data. Labels corresponding to the training sample may be predicted oil distribution parameters corresponding to the sample candidate position scheme. In some embodiments, the training sample may be obtained from historically collected data, and the labels may be obtained through manual labeling.

An exemplary joint training process includes: inputting the sample oil distribution map into an initial feature extraction layer to obtain the oil distribution parameters output by the initial feature extraction layer; inputting the oil distribution parameters output by the initial feature extraction layer, the sample wind speed sensor readings, the candidate distribution scheme corresponding to the sample candidate position scheme, the candidate movement scheme corresponding to the sample candidate position scheme, and the sample environmental data into an initial distribution prediction layer to obtain predicted oil distribution parameters corresponding to a sample candidate position scheme output by the initial distribution prediction layer; and establishing a loss function based on the labels and the output of the initial distribution prediction layer to update parameters of the model until a preset condition is met, and the training is completed. The preset condition may be that the loss function is smaller than a threshold, converges, or a training period reaches a threshold.

In some embodiments, the control system may determine recovery efficiency in a plurality of ways based on the predicted oil distribution parameters. In some embodiments, the control system may determine corresponding recovery efficiency in a preset comparison table by means of table lookup based on a sum of oil coverage rates of each sub-area in the predicted oil distribution parameters. The preset comparison table includes a corresponding relationship between the oil coverage rate and the recovery efficiency, and the preset comparison table may be determined based on prior knowledge or historical data.

In some embodiments, the control system may determine the recovery efficiency based on the sum of the oil coverage rates of each sub-area in the predicted oil distribution parameters and the sum of the oil coverage rates of each sub-area in the current oil distribution parameters. Exemplarily, the recovery efficiency may be determined by the following formula (2):

$$w = \frac{Q 1 - Q 2}{Q 1} \times 100 \% \qquad ( 2 )$$

where w denotes the recovery efficiency, Q1 denotes the sum of the oil coverage rates of each sub-area in the current oil distribution parameters, and Q2 denotes the sum of the oil coverage rates of each sub-area in the predicted oil distribution parameters.

The control system may determine the evaluation value based on the recovery efficiency in a plurality of ways. In some embodiments, the control system may determine the evaluation value by table lookup based on the recovery efficiency. A corresponding relationship between the evaluation value and the recovery efficiency may be preset by the system or manually.

In some embodiments of the present disclosure, based on a comparison of multiple sets of different candidate position schemes with the historical optimal solution, a direction of the iteration and a size of adjustment range are dynamically adjusted, making the iteration more targeted and approaching a superior candidate position scheme faster. By combining the individual optimal solution and the group optimal solution, the process of iteration may better combine a local exploration and a global situation, improving the accuracy and speed of the iteration, helping to converge faster, reducing iteration times, and improving iteration efficiency when iterative updating.

The target position scheme may be determined through multiple rounds of iterative updates. In some embodiments, the control system may determine the target distribution scheme and a plurality of corresponding target movement schemes based on the target position scheme.

For a certain target position scheme, a corresponding target distribution scheme and multiple target movement schemes are determined in a similar manner for determining the candidate distribution scheme corresponding to the candidate position scheme, and multiple candidate movement schemes. Further descriptions may be found hereinabove, which are not repeated.

In step 840, adjusting, based on the target distribution scheme and the target movement scheme, the position of the at least one recovery device.

In some embodiments, the control system may adjust the position of at least one recycling device based on the target movement scheme, so that the position of at least one recycling device conforms to the target distribution scheme.

In some embodiments, the control system may also determine whether a movement direction of the at least one recovery device deviates when at least one recovery device is arranged.

In some embodiments, in response to a deviation of the movement direction of the at least one recovery device when executing the target movement scheme, the control system may determine the target water outlet pipe based on the deviation direction, and control a corresponding backup water outlet pipe to continue working instead of the target water outlet pipe.

The deviation direction refers to a direction of deviation from the movement direction.

Whether there is a deviation in the movement direction and the deviation direction may be determined in a plurality of ways. For example, the monitoring images taken in the movement of the recovery device may be obtained, and the monitoring images may be analyzed and processed to determine whether there is a deviation in the movement direction and determine the deviation direction.

The target water outlet pipe may be determined in a plurality of ways. In some embodiments, based on the deviation direction, the control system may determine a water outlet pipe close to a side of the deviation direction as the target water outlet pipe. For example, if the deviation direction is left, it is determined that the water outlet pipe on the left side malfunctions. By correcting the deviation in the moving direction, the control system can better grasp the moving situation of the recovery device and improve recovery efficiency.

In some embodiments of the present disclosure, adjustments may be made in time by judging whether the movement direction of at least one recovery device deviates when executing the target movement scheme; and an adjustment scheme for the recovery device may be determined by determining the deviation direction, so that the control system may intelligently arrange the recovery device according to the actual situation

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of the present disclosure are not necessarily all referring to the same embodiment. In addition, some features, structures, or characteristics of one or more embodiments in the present disclosure may be properly combined.

Furthermore, the recited order of processing elements or sequences, or the use of numbers, letters, or other designations therefore, is not intended to limit the claimed processes and methods to any order except as may be specified in the claims. Although the above disclosure discusses some embodiments of the invention currently considered useful by various examples, it should be understood that such details are for illustrative purposes only, and the additional claims are not limited to the disclosed embodiments. Instead, the claims are intended to cover all combinations of corrections and equivalents consistent with the substance and scope of the embodiments of the invention. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A recovery device for oil spilling on water, wherein the recovery device comprises a casing, a control center, a variable pressure airbag, a water suction pump, and a drain pipe; wherein
the casing is of a hollow structure, which is used to accommodate an oil-water mixture and used as a temporary oil collection tank, an upper part of the casing is provided with an oil-water mixture inlet, a bottom of the casing is provided with a drain port, and a side wall of the casting is provided with an oil suction port;
the variable pressure airbag is arranged outside the casing, which is configured to adjust buoyancy of the recovery device;
one end of the water suction pump is connected to the drain port, the other end of the water suction pump is connected to the drain pipe, and the water suction pump is configured to pump out water in the casing and discharge the water to a water environment outside the casing through the drain pipe; and
the control center is arranged on the casing, and the control center is communicatively connected with the variable pressure airbag and the water suction pump respectively for controlling volume of the variable pressure airbag and startup and shutdown of the water suction pump.

2. The recovery device according to claim 1, wherein the recovery device further comprises an oil detector and an isolation layer;
the isolation layer is arranged inside the casing for water penetration and oil separation;
the oil detector is arranged on an inner wall of the casing to detect a position of an oil level, when the oil level touches the oil detector, the oil detector sends a detection result to the control center; and
the control center is communicatively connected with the oil detector for controlling the volume of the variable pressure airbag and the startup and shutdown of the water suction pump according to the detection result of the oil detector.

3. The recovery device according to claim 2, wherein the recovery device further comprises an oil discharge pump and an oil suction pipeline, the oil discharge pump is arranged on the isolation layer, one end of the oil suction pipeline is connected to the oil discharge pump and the other end of the oil suction pipeline is connected to a recovery vessel recovering spilled oil, and the oil discharge pump is configured to discharge oil collected in the casing to the recovery vessel through the oil suction pipeline; and
the control center is also communicatively connected with the oil discharge pump for controlling the startup and shutdown of the oil discharge pump.

4. The recovery device according to claim 1, wherein the oil-water mixture inlet is provided with a filter.

5. The recovery device according to claim 1, wherein the recovery device further comprises at least two fixed columns, the at least two fixed columns are configured to support and connect the control center, one end of each of the at least two fixed columns is arranged on the casing, and the other end of each of the at least two fixed columns is connected to the control center.

6. The recovery device according to claim 5, wherein the at least two fixed columns are arranged on the casing around the oil-water mixture inlet, and the control center is arranged overhead on an upper part of the oil-water mixture inlet through the at least two fixed columns.

7. The recovery device according to claim 2, wherein the isolation layer comprises a hydrophilic-oleophobic membrane and rigid filters disposed on an upper portion and a lower portion of the hydrophilic-oleophobic membrane.

8. The recovery device according to claim 2, wherein the oil detector includes a first oil detector and a second oil detector, and a height of the first oil detector on the inner wall of the casing is higher than that of the second oil detector on the inner wall of the casing, and the second oil detector is arranged at a connection between the isolation layer and the inner wall of the casing.

9. The recovery device according to claim 1, wherein the recovery device further comprises an airbag support frame, the airbag support frame is arranged outside the casing, and the airbag support frame is configured to support the variable pressure airbag and fix the variable pressure airbag outside the casing.

10. The recovery device according to claim 1, wherein the recovery device comprises a driving component for controlling movement of the recovery device;
the driving component is composed of a water suction pipe, a water outlet pipe, a backup water outlet pipe, a water pump, and a connecting shaft, electric control valves are arranged in the water outlet pipe and the backup water outlet pipe;
one end of the water suction pipe is connected to the water pump, the other end of the water suction pipe is connected to the water outlet pipe and the backup water outlet pipe, and the other end of the water suction pipe is connected to the bottom of the casing through the connecting shaft; the water pump is configured to suck water in a water environment outside the casing into the water suction pipe, and discharge the water through the water outlet pipe or the backup water outlet pipe; and
the control center is communicatively connected with the electric control valves for controlling the startup and shutdown of the water outlet pipe and the backup water outlet pipe.

11. A recovery vessel for oil spilling on water, wherein the recovery vessel comprises a recovery vessel body and a recovery device, wherein
the recovery device comprises a casing, a control center, a variable pressure airbag, a water suction pump, and a drain pipe; wherein
the casing is of a hollow structure, which is used to accommodate an oil-water mixture and used as a temporary oil collection tank, an upper part of the casing is provided with an oil-water mixture inlet, a bottom of the casing is provided with a drain port, and a side wall of the casting is provided with an oil suction port;
the variable pressure airbag is arranged outside the casing, which is configured to adjust buoyancy of the recovery device;
one end of the water suction pump is connected to the drain port, the other end of the water suction pump is connected to the drain pipe, and the water suction pump is configured to pump out water in the casing and discharge the water to a water environment outside the casing through the drain pipe; and
the control center is arranged on the casing, and the control center is communicatively connected with the variable pressure airbag and the water suction pump respectively for controlling volume of the variable pressure airbag and startup and shutdown of the water suction pump;
the recovery vessel body comprises an oil storage tank and an oil boom; the oil storage tank is configured to store spilled oil recovered by the recovery device, and the oil boom is configured to enclose an oil-spilling water area.

12. The recovery vessel according to claim 11, wherein the recovery vessel further comprises a telescopic tractor, which is arranged on the recovery vessel body, a free end of the telescopic tractor is connected to the recovery device, and the telescopic tractor is configured to adjust a position of the recovery device.

13. The recovery vessel according to claim 12, wherein the recovery vessel further comprises a control system for controlling the telescopic tractor to adjust position of at least one recovery device.

14. A control method for a recovery device for oil spilling on water, which is implemented based on the recovery vessel, and the method is executed by a control system of the recovery vessel, comprising:
obtaining an oil distribution map of an oil-spilling water area in an oil boom;
determining, based on the oil distribution map and an oil collection situation of at least one recovery device, whether the at least one recovery device meets a preset movement condition;
in response to a determination that the at least one recovery device meets the preset movement condition, determining, based on the oil distribution map, a target distribution scheme and a target movement scheme; and
adjusting, based on the target distribution scheme and the target movement scheme, position of the at least one recovery device.

15. The control method according to claim 14, wherein the determining, based on the oil distribution map, a target distribution scheme and a target movement scheme comprises:
determining, based on the oil distribution map, the target distribution scheme and the target movement scheme through a preset algorithm.

16. The control method according to claim 14, wherein the method further comprises:
in response to a deviation in a movement direction of the at least one recovery device when executing the target movement scheme,
determining a target water outlet pipe based on a deviation direction, and controlling a corresponding backup water outlet pipe to continue working instead of the target water outlet pipe.
